(19) United States
(12) Patent Application Publication
(10) Pub. No.: US 2003/0045441 A1
(43) Pub. Date: Mar. 6, 2003

(54) Water-soluble package with hydrophobic capsules in the film

(75) Inventors: Feng-Lung Gordon Hsu, Tenafly, NJ (US); Edward John Giblin, Hopatcong, NJ (US)

Correspondence Address: UNILEVER, PATENT DEPARTMENT, 45 RIVER ROAD, EDGEWATER, NJ, 07020, US

(73) Assignee: Unilever Home and Personal Care, USA, Division of Conopco, Inc.

(21) Appl. No.: 09/940,734

(22) Filed: Aug. 28, 2001

(51) Int. Cl. C11D 17/00

(52) U.S. Cl. 510/296; 510/475

(57) ABSTRACT

A water-soluble single-use package for a detergent or personal care composition comprising hydrophobic capsules in the water-soluble body portion. Preferred detergent or personal care compositions are liquid. Preferred capsules are transparent/translucent.

### FIELD OF THE INVENTION

A water-soluble single-use package for a detergent or personal care composition comprising hydrophobic capsules in the water-soluble body portion.

### BACKGROUND OF THE INVENTION

Detergent compositions and personal care compositions are provided in many forms. Probably, the most prevalent forms are granular and liquid compositions. More recently, unit dose forms of detergent have been proposed in the form of compressed tablets of detergent powder or water-soluble packages. The unit dose forms are preferred by some consumers, in that the dose is pre-measured and, consequently, the unit dose form is faster, easier and less messy to use. Water-soluble packages filled with liquid detergent composition are desired especially by consumers who are used to liquid detergents.

Water-soluble unit dose liquid detergent packages are known. See, for instance, Kennedy (U.S. Pat. No. 4,973,416), Dickler et al. (U.S. Pat. No. 6,037,319), Haq (U.S. Pat. No. 4,416,791) and Richardson (U.S. Pat. No. 4,115,292).

Perfume-containing films, some of which may be water-soluble films are disclosed by Staller (U.S. Pat. No. 4,540,721), Whyte (U.S. Pat. No. 4,339,356), Seiner (U.S. Pat. No. 3,655,129), Oishi et al. (U.S. Pat. No. 5,190,712), McDermott et al. (U.S. Pat. No. 5,543,439) and Shefer et al. (U.S. Pat. No. 6,063,365).

In many articles of commerce, particularly consumer products, it is desirable to separate certain ingredients, yet have them disposed in a common container. Separation is particularly beneficial where one or more ingredients have negative interactions with each other. For example, in laundry detergents, enzymes are useful in removing stains but it is also best to separate them from other constituents, such as sources of alkalinity and surfactants, especially anionic surfactants like linear alkylbenzene sulfonates or alkyl sulfates. Bleaches, vitamins, perfumes, vegetable oils, plant extracts and ceramides are further examples of ingredients that sometimes need to be separated from the rest of the detergent or personal care composition.

A known technique for separating ingredients in a common container includes encapsulation. Encapsulation technology is well known for different applications. Generally, encapsulation includes a medium that surrounds at least one component and thereby provides a barrier between the “encapsulated” component and other components. The barrier is typically temporary and is designed to break down and release the encapsulated material at a desired time, such as at a particular temperature, upon reaction or dissolution with chemicals, or due to mechanical stress. Methods of encapsulation include coacervation, liposome formation, granulation, coating, emulsification, atomization and spray-cooling.

See, for instance, the disclosures of enzyme encapsulates and encapsulation processes: Falholt et al. (U.S. Pat. No. 4,906,396, UK 2,186 884, and EP 0 273 775), Tsaur et al. (U.S. Pat. Nos. 5,434,069 and 5,441,660), Ratuiste et al. (U.S. Pat. No. 5,589,370). JP 41003667 discloses a dialysis of a protein solution against polyol-base polymer. See also Mitchnik et al. (U.S. Pat. No. 5,733,531) and Leong (U.S. Pat. No. 5,296,166). WO 01/05949 discloses a method for increasing the density of enzyme capsules.

Despite numerous capsules in the prior art, a problem remains to produce a commercially attractive capsule which is stable—the encapsulated ingredient should not leach out of the capsule upon storage (especially important is the stability of capsules in liquid compositions)—but should release the protected ingredient with ease during normal use.

An additional challenge is that the capsules need to be manufactured with relative ease. For instance, in some prior art capsules the melt temperature of the encapsulating material may damage the encapsulated material during the encapsulation process. In the case of perfume encapsulation, for example, many perfumes are essential oils which are volatile, and thus can particularly benefit from low temperature processing. Yet, typical encapsulating ingredients, e.g. wax, have a high melting temperature.

A further problem with capsules for consumer products is the manufacture of either transparent or colored capsules. The encapsulating material, e.g. wax, is typically opaque. In such capsules the opaque shell obscures the color; neither can the transparency be attained. Yet, it is frequently desirable to produce a transparent or colored capsule to increase the appeal of the consumer product.

It is desirable to increase the visual appeal of the water-soluble package and also provide a unique appearance to be associated by consumers with a particular product. In addition, it is desirable to provide a visual signal to a consumer of the presence of special (i.e., benefit) ingredient in the composition. At the same time, the benefit ingredients, e.g. perfumes, enzymes, bleaches or moisturizing oils, need to be protected to preserve their activity in the composition, especially when such composition includes water and/or surfactant.

Thus, it is desirable to provide a water-soluble package which contains capsules within the film, the latter forming the water-soluble body portion of the package. The capsule-containing film serves to provide a unique appearance to the product, and may, at the same time, be employed to entrap, or protect, a benefit agent and/or colorant.

### SUMMARY OF THE INVENTION

The present invention includes a water-soluble package for use in a single application comprising a detergent or personal care composition contained within a water-soluble body portion, the body portion comprising a water-soluble film composition, the film composition comprising capsules comprising a hydrophobic ingredient for forming the capsules.

Preferred detergent or personal care compositions are liquid. Preferred capsules are transparent/translucent.

The following detailed description and the examples illustrate some of the effects of the inventive compositions. The invention and the claims, however, are not limited to the following description and examples.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

For the avoidance of doubt the word “comprising” is intended to mean including but not necessarily “consisting of” or “composed of.” In other words the listed steps or options need not be exhaustive.

The term “hydrocarbon oil” as used herein means a hydrocarbon oil having a maximum viscosity of about 10 kg/(m)(sec), preferably no greater than about 5 kg/(m)(sec).

The term “continuous” does not necessarily mean “isotropic”. The term “continuous” is used herein to denote the phase which is predominant in volume during emulsification or dispersion of discontinuous phase in the continuous phase.

The term “wax” as used herein means a hydrophobic material which is a solid at 20° C. By “solid” is meant the ingredient is not mobile at 20° C.

Capsules

According to the present invention, the capsules are incorporated into a water-soluble film. The capsules are immiscible with the film. Generally, the capsules are hydrophobic in nature, to prevent their diffusion into the hydrophilic film. As will be apparent from the preparation description below, the capsules are preferably prepared in-situ in the film, as part of the film casting process.

The hydrophobic ingredient for the capsules is generally selected from the group consisting of paraffin, wax, oil, petrolatum, a hydrophobic polymer and mixtures thereof.

In one embodiment of the invention, the hydrophobic ingredient is employed alone to form the immiscible capsules, e.g., to provide a unique appearance to the package. Some hydrophobic ingredients may provide a functional benefit, e.g. sunflower oil as a moisturizer.

In another embodiment of the invention, the hydrophobic ingredient is employed in combination with a hydrophobic (i.e., oil-soluble) benefit agent and/or colorant, preferably a perfume.

In yet another embodiment of the invention, a hydrophobic ingredient forms a continuous phase (also sometimes referred to herein as “shell”) which surrounds a discontinuous phase. The discontinuous phase may itself be a benefit agent and/or a colorant or it may contain an additional benefit agent and/or colorant.

The film generally includes from 1% to 40% of the capsules, more preferably from 2 to 30%, most preferably from 3 to 25%, and optimally from 5% to 20%, in order to provide sufficient visual appeal and/or delivery of the benefit ingredient (% by weight of the film).

Hydrophobic Ingredient

In one preferred embodiment of the invention, a mixture of a thermoplastic block co-polymer and a hydrocarbon oil is employed, particularly when it is desired to make a transparent/translucent (colored or uncolored) capsules. The block co-polymers particularly suitable in the present invention are block co-polymers containing at least one rigid block and at least one flexible block. The mixture of the hydrocarbon oil and the block co-polymer according to the present invention is isotropic at 20° C. It should be understood that since the co-polymer is not pourable at 20° C. (indeed, it is solid), it may be difficult to combine the co-polymer with the oil at such temperature to ascertain whether the mixture is isotropic. According to the present invention, a mixture may be formed at any suitable temperature at which the liquefied co-polymer forms an isotropic liquid mixture with the oil. The copolymer/oil mixtures suitable for use in the present invention, however, remain isotropic after cooling. Suitable isotropic mixtures have transmittance of at least 50%, preferably at least 70%, as measured by UV-visible spectrophotometer (measured in visible light range).

Block Co-Polymer

In one embodiment of the invention, the co-polymer employed in the layer is selected from the group consisting of a triblock co-polymer, radial co-polymer, and multiblock co-polymer, the co-polymer comprising at least one triblock with a structure: rigid block—flexible block—rigid block. In another embodiment of the invention, a di-block co-polymer is employed; rigid block-flexible block. Preferably the rigid block is styrene-type polymer, and the flexible block is rubber-type polymer.

By virtue of employing the co-polymer, the viscosity of the oil is increased, and the viscous or hardened continuous phase is formed, yet the resulting composition is sufficiently soft and friable to release the optional discontinuous phase or the benefit ingredient in normal use. The co-polymer blends uniformly with oil at a temperature which is much lower than the melting point of wax, thus allowing for protection of temperature-sensitive ingredients, e.g. bleach, perfume, enzyme, vegetable oil, etc. A further advantage of using the co-polymer is that it is not necessary (although possible) to use a surfactant in preparing a uniform distribution of the optional discontinuous phase in the continuous phase; the avoidance of the surfactant makes the encapsulation process easier and cheaper. Furthermore, the absence of surfactant improves the stability of the encapsulated ingredient, since the surfactant provides for a potential channel of penetration for an external environment.

The preferred co-polymers are transparent and uncolored, in order to attain a transparent and uncolored continuous phase.

Examples of suitable co-polymers include but are not limited to those that are described in Morrison et al. (U.S. Pat. No. 5,879,694) hereby incorporated by reference herein.

Each of the diblock, triblock, radial block and/or multiblock copolymers in the invention contains at least two thermodynamically incompatible segments. By the expression thermodynamically incompatible with respect to the polymers, it is meant that the polymer contains at least two incompatible segments, for example at least one hard and one soft segment. In general, in a triblock polymer, the ratio of segments is one hard, one soft, one hard or an A-B-A copolymer. The multiblock and radial block copolymers can contain any combination of hard and soft segments, provided that there are both hard and soft characteristics. In the diblock copolymer, the blocks are sequential with respect to hard and soft segments.

Commercially available thermoplastic rubber type polymers which are especially useful in forming the compositions of the present invention are sold under the trademark Kraton® by Shell Chemical Company. The Kraton® rubber polymers are described as elastomers which have an unusual combination of high strength and low viscosity and a unique molecular structure of linear diblock, triblock and radial copolymers. Each molecule of the Kraton® rubber is said to consist of block segments of styrene monomer units and rubber monomer and/or comonomer units. Each block segment may consist of 100 or more monomer or comonomer units. The most common structure is the linear ABA block type; styrene-butadiene-styrene (SBS) and styrene-isoprene-styrene (SIS), which is the Kraton® D rubber series.

A second generation polymer of this general type is the Kraton® G series. This copolymer comprises a styrene-ethylene-butylene-styrene type (S-EB-S) structure. The Kraton® G series is preferred in the practice of the invention, as the copolymers of this series are hydrogenated and thus more thermally stable; that is, decomposition is less likely to occur during blending of the G series polymers with the oil (the D series polymers having unsaturation within the rubber block). The Kraton® G rubbers are indicated as being compatible with paraffinic and naphthenic oils and the triblock copolymers are reported as taking up more than 20 times their weight in oil to make a product which can vary in consistency from a “Jello®” to a strong elastic rubbery material depending on the grade and concentration of the rubber. The diblock polymers include the AB type such as styrene-ethylenepropylene (S-EP) and styrene-ethylenebutylene (S-EB), styrene-butadiene (SB) and styrene-isoprene (SI).

Preferably, when Kraton® series block co-polymers are employed (i.e., styrene-elastomer block co-polymers), the oil is essentially free of silicone-containing oils, in order to obtain optimum isotropic mixtures. By “essentially free” is meant that in the Kraton®/oil continuous phase, the amount of silicone-containing oil is preferably less than 2%, by weight of the continuous phase, more preferably less than 1%, most preferably less than 0.5% and optimally is 0%.

The preferred polymer is the diblock co-polymer (having rigid-flexible blocks), even in the absence of a triblock or radial co-polymer. Kraton® 1702 is a diblock co-polymer (styrene-ethylene/propylene). The properties of Kraton® 1702 make it more suitable for use as a viscosity modifier in making the emulsion, rather than capsules. Kraton® 1702 is particularly preferred when transparent capsules or a transparent hydrophobic continuous phase is desired.

In another embodiment of the invention, a triblock co-polymer of the Kraton® G type, in particular Kraton® G-1650. Kraton® G-1650 is an SEBS triblock copolymer which has a specific gravity of about 0.91, and is said to have a tensile strength of about 3.45 newton/m2 as measured by ASTM method D-412-tensile jaw tester separation speed 25.4 cm/min. The styrene to rubber content of Kraton® G-1650 is said by the manufacturer to be about 29:71, and the Brookfield viscosity is about 8 kg/(m)(sec)(toluene solution, at 25° C., 25%w). The Shore A hardness is about 75.

The mixture of Kraton® 1650 with Kraton® 1702 may be preferred in some cases, in order to increase the friability of the capsules, while preserving transparency. When using the mixture of two Kraton polymers, the weight ratio of Kraton® 1650 to Kraton® 1702 is generally from 1:10 to 10:1, more preferably from 3:1 to 7:1, most preferably from 2:1 to 5:1, and optimally from 1:1 to 4:1.

The block co-polymer is employed in the inventive compositions generally in an amount of from 0.1% to 15%, more preferably from 0.5% to 10%, most preferably from 0.5% to 7%, and optimally from 1% to 4%, by weight of the continuous phase (or by weight of the layer, if only a hydrophobic phase is present).

In another preferred embodiment, a mixture of oil and wax is employed to produce an oil/wax dispersion with a viscosity at shear rate of 10⁻⁴ 1/sec in the range of 10 kg/(m)(sec) to 5000 kg/(m)(sec). Suitable commercial oil/wax mixtures include Petrolatum® and Tro Grees®.

In yet another embodiment, a mixture of oil, wax, and the block co-polymer is employed. In general, the capsules or emulsions which employ a mixture of oil, wax and the block co-polymer exhibit better transparency and maintain friability for release. In such mixtures, the block co-polymer is present generally in an amount of from 0.1 to 10%, more preferably from 0.5% to 7%, and most preferably from 1% to 5%. The wax is present generally in an amount of from 0.1% to 15%, more preferably from 0.5% to 10%, and most preferably from 1% to 7%.

Hydrocarbon Oil

Natural or synthetic hydrocarbon oil or mixtures thereof may be employed.

Generally, the hydrocarbon oil may be a paraffinic oil, a naphthenic oil, natural mineral oil or the like. Examples include but are not limited to mineral oil, castor oil, vegetable oil, corn oil, peanut oil, jojoba oil, 2-ethylhexyl oxystearate (and other alkyl oxystearates), acetylated lanolin alcohol, alkyl palmitates such as isopropyl palmitate, 2-ethylhexyl palmitate, glycerol triacetates, disopropyl adipate, dioctyl adipate (and other alkyl adipates), isopropyl myristate, C12 to C15 alcohol benzoates, and the like.

Most preferably, the oil is mineral oil, because it is both economic and most easily processable.

When the capsules include optional discontinuous phase, the hydrophobic continuous phase may include a surfactant as an emulsifier. Suitable surfactants are low HLB surfactants, which may be anionic, cationic, amphoteric, and nonionic, preferably having an HLB of 1 to 10, more preferably from 2 to 7 and most preferably less than 5. In the most preferred embodiment, the surfactant is Neodol® 25-3 available from Shell Chemical Co. The continuous phase generally includes from 0 to 10% of a surfactant, more preferably from 0.1 to 5%, most preferably from 0.3 to 4%, and optimally from 0.5% to 3%, in order to form an emulsion, yet to avoid the formation of a reverse emulsion (% by weight of the total continuous phase).

Oil-Soluble Benefit Agent

The continuous phase preferably includes an oil-soluble benefit agent.

In the preferred embodiment of the invention, the oil-soluble benefit agent is included in the continuous phase comprised of the block copolymer/hydrocarbon oil described above, in order to attain the benefits associated with lower processing temperatures, and/or to attain the transparent capsules. In this embodiment, the oil-soluble benefit agent forms an isotropic mixture with co-polymer/hydrocarbon oil mixture when heated, but, on cooling, the mixture may or may not remain isotropic. Thus, the isotropicity of the copolymer/hydrocarbon oil (and thus the suitability of the chosen oil) should be tested in the absence of the oil-soluble benefit agent.

According to invention, by mixing the oil-soluble benefit agent with the hydrophobic ingredient, the viscosity of the benefit agent is increased. The increased viscosity is advantageous for several reasons: it entraps the benefit agent; it reduces the volatility of low boiling point benefit agents (e.g., perfumes); and it allows for increased deposition and/or increased substantivity of the benefit agent on the clothes or skin. In the preferred embodiment of the invention, when the block co-polymer/hydrocarbon oil mixture is employed, particularly in case of volatile or temperature-sensitive benefit agents (e.g., essential oils and perfumes), the capsule manufacture does not damage the benefit agent, due to the low melting point processing of block co-polymers compared to the higher melting point of traditional encapsulating materials.

Suitable oil-soluble benefit agents include but are not limited to essential oils, perfumes, vitamins, vegetable oils, plant extracts, anti-wrinkle compounds, photoprotective agents, dye fixative agents, antioxidants, insecticides, soil repelling agents, soil release agents, anti-bacterial agents, cationic surfactants, lubricants, moisturizers.

The most preferred oil-soluble benefit agent is perfume, since perfumes are difficult to encapsulate at traditionally high encapsulating temperatures, and perfumes benefit from the increased viscosity, to optimize substantivity to the clothes and enhanced deposition.

Oil-soluble benefit agents are described in further detail below, under Detergent Compositions and Personal Care Compositions sections.

The continuous phase generally includes from 0 to 60%, more preferably from 10% to 50%, most preferably from 15% to 40%, and optimally from 20% to 35%, of the oil-soluble benefit agent in order to optimize the benefit (% by weight of the total continuous phase).

Discontinuous Phase

The desired ingredient to be protected (e.g., benefit ingredient or a colorant) may form a continuous phase with the hydrophobic ingredient (it can then be co-melted with the hydrophobic material) or it may form a discontinuous (hydrophilic or incompatible hydrophobe) phase. In the latter case, the hydrophobic material forms a continuous phase, which surrounds a discontinuous phase. A hybrid of the two cases is also possible, i.e. both the continuous and discontinuous phases contain benefit ingredient(s) and/ or colorant(s).

If present, the discontinuous phase of the inventive capsules is itself and/or comprises a benefit agent and/or a colorant. In some embodiments of the invention, the discontinuous phase is itself a benefit agent, e.g. a vegetable oil, such as sunflower seed oil, in personal care compositions. In other embodiments, the discontinuous phase is itself a colorant (e.g. a solid pigment). Still in other embodiments the discontinuous phase serves as a vehicle for a benefit agent and/or colorant. And still in other embodiments of the invention the discontinuous phase may itself be a benefit agent and/or colorant and also further include an additional benefit agent and/or colorant. According to the present invention, the discontinuous phase is immiscible with the continuous phase, to prevent the exposure of the continuous phase to the environment outside the capsule. The discontinuous phase may be a solution (aqueous or oil), an oil, an emulsion, a dispersion, or a solid. The preferred form of the discontinuous phase is an oil or a solution (oil or aqueous solution), due to the relative ease of incorporation of the oil or the solution into the continuous phase. The capsules may include more than one discontinuous phase.

If the additional benefit agent/colorant is oil-soluble, than an oil is chosen to carry the benefit agent/colorant in the discontinuous phase; if the benefit agent/colorant is water-soluble, than the discontinuous phase is an aqueous solution. Of course, as mentioned above, solids may be employed, without making a solution.

The discontinuous phase may be present in an amount of from 0.01 to 45%, more preferably from 5 to 45%, most preferably from 10 to 40%, and optimally from 20 to 35%, (% by volume of the capsules in order to deliver sufficient benefit agent/colorant, provide an adequate protection for the benefit agent/colorant and to maintain the ease of processing.

For capsules which contain a discontinuous phase, the continuous phase may sometimes be referred to hereinafter as a “shell” or “shell material”.

Benefit Agent

For simplicity, the material entrapped within the shell, either directly, or as a discontinuous phase, will be referred to as an “enzyme”. However, it is within the scope of the present disclosure that materials other than enzymes can be encapsulated by the techniques disclosed herein. The choice of the benefit agent depends largely on whether the final consumer composition is a detergent composition or a personal care composition. As mentioned above, the continuous or discontinuous phase itself may represent a benefit agent, so it is not necessary that an additional benefit agent be present. Thus, an additional benefit agent may be present in an amount of from 0 to 100%, preferably 0.01 to 50%, more preferably 0.1 to 20%, by weight of the discontinuous phase.

Typical additional benefit agents include, but are not limited to a bleach, a bleach precursor, a surfactant, an enzyme, a whitening agent, a fabric softener, an anti-wrinkle compound, a dye fixative, dye transfer inhibitors, anti-redeposition polymers, soil release polymers, an anti-foam agent, a perfume, a silicone oil, a vegetable oil, a vitamin, a plant extract, a hydroxy acid, an anti-oxidant, an anti-bacterial agent, a moisturizer, and mixtures thereof.

If the encapsulated material is an enzyme, the preferred enzymes include proteases, lipases, cellulase, amylase, bleaching enzymes and the like. When selecting enzymes for a liquid detergent system, the most preferred enzymes include proteases and cellulases.

In the case of an enzyme, the discontinuous phase is an aqueous solution of the enzyme. The aqueous enzyme solution may optionally contain a low HLB surfactant, in order to further enhance the formation of the emulsion. If present, the surfactant may be chosen from and employed in the same amounts as the surfactants described above for the continuous phase. The level of the surfactant can be reduced or even eliminated, particularly if suitable agitation is used. Furthermore, the need for surfactant is entirely eliminated if the shell material is a mixture of thermoplastic polymer with oil, rather than a wax/oil mixture.

Colorant

The colorant may be a dye or a pigment. Dyes are preferable, since they are water-soluble and thus are more easily incorporated into the layer emulsion, compared to pigments which are typically not water-soluble. Most preferably, a water-soluble dye is entrapped, alone or in the mixture with a benefit agent, within a transparent, uncolored continuous phase.

Most preferably, the capsules contain both the benefit agent and the colorant, within a transparent continuous phase, to provide a visual signal to the consumer that a composition contains an additional beneficial ingredient.

Preparation of Capsules

The formed capsules may be incorporated into the film or they may be formed in situ during the film preparation. The in situ preparation is preferred, to minimize manufacturing costs.

In the in situ preparation, the hydrophobic continuous phase is melted and may then be mixed with either an oil-soluble benefit agent or a discontinuous phase, or both. The resulting solution or emulsion or dispersion is mixed with a solution of a water-soluble film in water (e.g., 1:4 ratio of film to water). The mixture may be prepared at a relatively low temperature, to protect sensitive benefit ingredients if present (e.g. 30-45° C.). The result is an emulsion in the water-soluble film. The emulsion is cast and baked in the oven to form a film with capsules.

Composition within the Package

The composition within the package may be solid (powder, granules, tablet or block) or fluid. Preferably, the composition is fluid. If fluid, the composition may be a liquid, a gel or a paste. If the substance is a liquid then preferably the liquid has a viscosity between 0.1 and 1 kg/(m)(sec), more preferably between 0.3 and 8 kg/(m)(sec), even more preferably between 0.5 and 0.7 kg/(m)(sec), and most preferably about 0.6 kg/(m)(sec), when measured at 20° C. at 10 s−1. In a preferred embodiment of the invention, the composition is present in an amount of between 10 and 500 ml, preferably between 20 and 100 ml, most preferably between 25 and 50 ml. Suitably, the package contains between 20 and 30 ml of a fluid composition.

Various detergent compositions include, but are not limited to laundry compositions, hard surface cleaners, dishwashing compositions. In a particularly preferred embodiment of the invention the fluid composition is a laundry treatment such as a laundry detergent, fabric conditioner or fabric care formulation.

Preferred laundry compositions comprise a surfactant, in an amount from 1 to 70% more preferably from 10 to 50%, most preferably from 15 to 35%, and optimally from 17 to 30% (% by weight of the laundry composition). Suitable detergent and laundry surfactants are well known to one of ordinary skill in the art and may in general be chosen from anionic, nonionic, amphoteric, and cationic surfactants. Preferably, the surfactant in the laundry compositions is anionic and/or nonionic, especially linear alkylbenzene sulfonate, alkyl ether sulfate, especially, alcohol ethoxylates and mixtures thereof.

In addition to the surfactant, the preferred laundry composition may include one or more well-known laundry ingredients, such as builders (from 0.1 to 40% for powders, from 0.1 to 20% for liquids), anti-redeposition agents, fluorescent dyes, perfumes, soil-release polymers, colorant, enzymes, buffering agents, etc.

Preferred detergent compositions are packaged in the water-soluble film containing capsules with encapsulated enzyme, bleach or bleach system, preferably in solution. Any bleach suitable for detergent application may be included. Examples include, but are not limited to chlorine bleaches, peracids, bleach precursors, alone or with oxygen sources.

In the capsules, if a bleach or an enzyme is entrapped, the capsules would generally include from 10% to 60%, more preferably from 15% to 50%, most preferably from 20% to 45% and optimally from 25% to 40%, of a bleach or an enzyme, in order to deliver an optimum benefit for minimum cost (% by weight of the capsules).

Personal care compositions according to the present include products which are rinsed off after application (e.g., shower gels, shampoos) and products that are left on after application (e.g., cosmetic lotions, gels and creams). Various personal care compositions include, but are not limited to, facial or body cleansing compositions, shampoo compositions, conditioner compositions, and cosmetic compositions. Personal care compositions may be in the form of solution, lotion, cream, or gel, and any combinations thereof.

Preferred personal care compositions comprise a cosmetically acceptable vehicle, in an amount from 0.1 to 70%, more preferably from 3 to 85%, most preferably from 5 to 95% and optimally from 10 to 99% (% by weight of the composition). Suitable vehicles are well known to one of ordinary skill in the art and may in general be chosen from isotropic liquid formulas or structured liquid formulas. Preferably, the vehicle in the personal care compositions is structured liquid formulas especially lamellar forming (structured) liquid formulas.

In addition to the vehicle, the preferred personal care composition may include one or more well-known personal care ingredients, such as viscosity builders (from 0.1 to 30%), pH controllers (stabilizers) (from 0.005 to 20%).

Preferred personal care compositions are personal wash or shampoo or hair conditioning compositions, wherein the capsules in the film surrounding the composition contain a combination of a benefit agent and a colorant, with the benefit agent chosen from vitamins, antibacterial agents, vegetable oils, cationic surfactant (e.g. quaternary ammonium) and mixtures thereof.

Vitamins include, but are not limited to A, E, C. Anti-bacterial agents include, but are not limited to Triclosan®. Vegetable oils include but are not limited to sunflower seed oil. The personal wash compositions include, in addition to the capsules and the vehicle, a surfactant, especially Tegobetaine® (Cocamidopropyl Betaine). The surfactant is included generally in an amount, more preferably form 0.1 to 10%, most preferably form 1 to 30%, and optimally from 20 to 60% (% by weight of the total composition).

The fluid compositions include some water, typically 1 to 15% water.

Preferably, the detergent or personal care composition is a transparent composition packaged in the clear/transparent film containing colored capsules and perfume.

Water-Soluble Body Portion

The package is preferably made of a clear, heat sealable, cold water soluble film such as polyvinyl alcohol. Thickness could range from 25 to 100 μm, more preferably from 35 to 80 μm, most preferably from 45 to 55 μm. Other materials from which the package can be made include but are not limited to methyl hydroxy propyl cellulose.

The water-soluble film, at least of the body wall, is thermoformable and, in one embodiment of the invention, is polyvinyl alcohol, or a polyvinyl alcohol derivative. Preferably the water soluble film of the base wall is the same material as that used to make the body wall. It is preferred that the body wall be thermoformed rather than cold formed because cold forming stresses the film and weakens the end package as a result.

The packages of the invention may be prepared from polyvinyl alcohol film, or other suitable material, which is filled, then sealed, preferably heat-sealed.

The package may take many shapes as viewed in a plan view, such as rectangular, square, round, triangular, etc.

In use, the package is mixed with water (e.g., inside a laundry machine or a dishwasher), or applied to the body and water is added, simultaneously or consecutively, in order to release the contents of the package and to dissolve the capsules.

The following specific examples further illustrate the invention, but the invention is not limited thereto.

Suppliers and chemical description of the ingredients used in the examples are summarized in the following table:

### EXAMPLE 1

A gel like solution was prepared by mixing 96.25% mineral oil (from Fischer Scientific) with 3.75% Kraton® 1702 (Styrene-(Ethylene-Propylene) di-block co-polymer from Shell Chemical) at 78° C. This was carried out under continuous stirring and heating in order to dissolve the Kraton® completely in the solution. The gel formed was allowed to cool down to 37.8° C. After cooling down, 20 g of the gel was mixed with 20 g of a perfume, Athena Extra® ex. Givaudan. The mixture was stirred until it formed a homogeneous solution. The perfume to gel ratio was 1:1. After forming the solution, 20 g of it was mixed with 80 g of the PVA (polyvinyl alcohol) solution made up of 1 part of PVA resin C72/FG ex PVAXX and 4 parts of water. Once again, the mixing was carried out at a low temperature of 37.8° C., to avoid perfume evaporation. The emulsification was carried out at agitation speed of around 600 rpm for 15 minutes in a fume hood to avoid the spread of the fragrance.

The resulting emulsion was immediately cast by spreading a thin layer with a spatula on a flat Plexiglas® sheet and baked in the oven at 60° C. for 15-20 minutes to form a 76.2 μm thickness polymeric film with about 20% of encapsulated perfume.

### EXAMPLE 2

Another type of perfume capsules was prepared in-situ in a PVA film to enhance the long lasting fragrance. A mixture of 80% mineral oil and 20% Bowax®840 (from IGI) was prepared at 60° C. After it cooled down to about 49° C., equal amount of perfume (Cuddle Up® ex. Givaudan), was added to the wax/oil mixture. 20 g of the resulting perfume mix was emulsified in 80 g of 28.6% PVA, C72-FG/T ex PVAXX, aqueous solution at the agitation speed of 600 rpm for 15 minutes in a fume hood. The resulting emulsion was immediately cast (as in Example 1) and baked in an oven at 60° C. for 20 minutes to form a film. The weight loss was 48%, therefore, the perfume level in the film was about 19%.

What is claimed is:

1. A water-soluble package for use in a single application comprising:
(a) a composition selected from the group consisting of a detergent and a personal care composition, for release on dissolution of the package,
(b) a water-soluble body portion for containing the composition, the body portion comprising a water-soluble film composition, the film composition comprising from about 1% to about 40% of capsules comprising a hydrophobic ingredient.

2. The package of claim 1 wherein the hydrophobic ingredient forms a hydrophobic continuous phase of the capsules.

3. The package of claim 1 wherein the hydrophobic continuous phase further comprises an oil-soluble benefit agent.

4. The package of claim 1 wherein the capsules further comprise from about 0.01% to about 45%, by volume of the capsules, of a discontinuous phase surrounded by the hydrophobic continuous phase.

5. The package of claim 4 wherein the discontinuous phase further comprises an ingredient selected from the group consisting of a benefit ingredient, a colorant, and mixtures thereof.

6. The package of claim 1 wherein the continuous phase comprises a hydrocarbon oil and from about 0.1% to about 15%, by weight of the continuous phase, of a diblock co-polymer comprising at least one rigid block and at least one flexible block.

7. The package of claim 6 wherein the capsules are transparent or translucent.

8. The package of claim 1 wherein the hydrophobic ingredient is selected from the group consisting of paraffin, oil, wax, petrolatum, a hydrophobic polymer, and mixtures thereof.

9. The package of claim 8 wherein the hydrophobic polymer is a thermoplastic polymer.

10. The package of claim 1 wherein the hydrophobic ingredient is a mixture of a thermoplastic polymer and hydrocarbon oil.

11. The package of claim 1 wherein the body portion is transparent.

12. The package of claim 1 wherein the composition is a laundry detergent composition.

13. The package of claim 12 wherein the laundry detergent composition is fluid.
